(19) United States
(12) Patent Application Publication
(10) Pub. No.: US 2025/0141107 A1
(43) Pub. Date: May 1, 2025

(54) Superdirective antenna loop

(71) Applicant: COMMISSARIAT A L’ENERGIE ATOMIQUE ET AUX ENERGIES ALTERNATIVES, PARIS (FR)

(72) Inventors: Frédéric MUNOZ, GRENOBLE Cedex (FR); Jean-François PINTOS, GRENOBLE Cedex (FR)

(21) Appl. No.: 18/932,503

(22) Filed: Oct. 30, 2024

(30) Foreign Application Priority Data
Oct. 31, 2023 (FR) 2311854

(51) Int. Cl. H01Q 7/00; H01Q 5/307

(52) U.S. Cl. CPC H01Q 7/00; H01Q 5/307

(57) ABSTRACT

An antenna includes a main radiating element of the loop antenna type, a first connection port and a second connection port disposed on either side of the main radiating element, a central element of the electric dipole type, circumscribed in the main radiating element, the central element being formed by two branches disposed symmetrically relative to an axis of symmetry passing through the first connection port and through the second connection port, the central element being powered at a third connection port located in the axis of symmetry, the main radiating element and the central element being coplanar.

### CROSS-REFERENCE TO RELATED APPLICATION

This application claims priority to foreign French patent application No. FR 2311854, filed on Oct. 31, 2023, the disclosure of which is incorporated by reference in its entirety.

### FIELD OF THE INVENTION

The present invention relates to an antenna, as well as to an antenna system and an antenna array. The invention is particularly adapted, but not limited, to wireless telecommunication systems, to radar systems, or to radio frequency metrology.

### BACKGROUND

5G telecommunications technology is based on several frequency bands. Among these frequency bands, the FR1-5G band uses frequencies below 6 GHz. In this sub-6 GHz band, in near-field/far-field measurements, highly compact directive antennas focus radiated energy, improve angular resolution and minimize the occupied space.

With regard to directivity, one of the methods that is often used involves producing an array of resonant elements in “End-Fire” mode, where the axis of maximum radiation is aligned with the axis of duplication of the radiating elements, thus resulting in a size that is limited but that is not very compact in the “End-Fire” orientation of the array. This is the case, for example, with the Yagi-Uda antenna, which is well known to a person skilled in the art.

Loop antennas are elementary antennas that are well defined throughout the literature. They can be very small compared with the wavelength. An example of a loop antenna is shown in FIG. 1. The loop antenna comprises an excitation point 21, and a metal loop 20, which can be formed by one or more turns, or can be formed by an integral flat track.

In particular, the transition from an in-plane radiation mode (see the radiation pattern 22 in FIG. 2) containing the loop to an out-of-plane radiation mode, when the circumference C of the loop approaches the wavelength λ, is illustrated in FIG. 2 (see radiation patterns 23 and 24).

The measurements in FIG. 2 are obtained with a constant value Ω, defined by:

$$Ω = 2 \cdot ln ( \frac{2 π a}{b} ) = 10$$

a corresponds to the radius of the loop, and b corresponds to the thickness of the loop along the z-axis.

The curve 31 corresponds to the directivity, along the z-axis and in dBi, of the antenna described in [1], as a function of the ratio C/λ. The ratio C/λ can be modified either by changing the size of the antenna (in this case the circumference) by setting a given frequency, or, for a given physical size, by varying the frequency across the wavelength.

When the circumference C of the loop is small compared to the wavelength A, typically when C/λ<0.5, the maximum radiation remains in the plane of the loop.

Indeed, the transition to the fundamental mode of the antenna is accompanied by a reduction in directivity along the axis orthogonal to the plane of the loop, and radiation tends to occur in the plane of the loop.

For loop antennas to be arrayed in “End-Fire” mode (superimposed in the direction of propagation orthogonal to the plane of the loop), there must be good directivity along the axis orthogonal to the plane of the loop.

However, the problem of maintaining directivity outside the plane of a loop arises when the antenna is miniaturized. This problem is clearly illustrated in reference 22 in FIG. 2, through a radiation null along the Oz-axis.

The variety of miniature antennas available throughout the literature is considerable and the design of a miniature, directional radiating element represents an additional challenge. Various approaches exist for addressing this requirement.

As shown in [2], some of the solutions propose the use of Huygens sources (dipole and loop with radiation in the plane of the loop), thus using the high natural directivity of this radiating element.

Other solutions are based on combined optimization between a dipole and a reflector plane (sometimes modified for the sake of compactness, a wide adaptation bandwidth and directivity, as described in [3]).

In the field of loop antennas, [4]proposes including an impedance tuning space in the vicinity of the loop.

In [5], coupling between elements is used, but without any particular constraint concerning the radiation pattern of the antenna.

These solutions do not address the aforementioned requirement for directivity and radiation control.

In the antenna described in [6], the use of loops close to the fundamental mode C/λ<0.5 does not take advantage of the natural compactness of the loops, which is linked to the use of higher modes, in which the loop radiates orthogonal to the plane containing said loop.

In [7], Yagi-Uda loop antennas are arrayed in an “End-Fire” arrangement.

However, the loops that are used are not miniature (C/λ≈1) and therefore exhibit maximum radiation orthogonal to the plane.

In [8], an excitation dipole is disposed inside a loop antenna located outside the plane defined by the excitation dipole, which allows the directivity of the antenna to be improved. However, the fact that the loop antenna is located outside the plane prevents it from being compactly arrayed in an “End-Fire” configuration.

### SUMMARY OF THE INVENTION

Thus, the invention aims to provide a compact and directive radiating element for use on its own or in an array.

Therefore, an aim of the invention is an antenna, comprising a main radiating element of the loop antenna type, a first connection port and a second connection port disposed on either side of the main radiating element, a central element of the electric dipole type, circumscribed in the main radiating element, the central element being formed by two branches disposed symmetrically relative to an axis of symmetry passing through the first connection port and through the second connection port, the central element being powered at a third connection port located in the axis of symmetry, the main radiating element and the central element being coplanar.

Advantageously, the dimensions of the main radiating element and of the central element are determined so that the impedance of the first connection port and of the second connection port have a zero real part.

Advantageously, each branch of the central element comprises a main strand that extends orthogonal to the axis of symmetry, and two auxiliary strands disposed on either side of the end of the main strand opposite the third connection port.

Advantageously, the main radiating element is made up of two semi-circles connected at the first connection port and the second connection port, and the auxiliary strands assume the shape of an arc of a circle, and wherein the following parameters are used to optimize the impedance of the first connection port and of the second connection port: the diameter of the main radiating element, the width of the main radiating element, the spacing between each of the semi-circles, the diameter of the arcs of a circle, the width of the arcs of a circle, and the length of the arcs of a circle.

Advantageously, the impedance of the first connection port and the impedance of the second connection port are determined by applying a superdirectivity algorithm.

Advantageously, the superdirectivity algorithm uses a radiation pattern method.

Advantageously, the first connection port and the second connection port each comprise a power supply circuit.

Advantageously, the first connection port comprises a load, and the second connection port comprises a power supply circuit.

The invention also relates to an antenna system, comprising an aforementioned antenna, and a reflector element placed close to the main radiating element and parallel to the plane of the main radiating element.

The invention also relates to an antenna array comprising at least two of the aforementioned antennas, with the antennas being arrayed in an “End-Fire” type configuration.

### BRIEF DESCRIPTION OF THE DRAWINGS

Further features, details and advantages of the invention will become apparent upon reading the description, which is provided with reference to the appended drawings, which are provided by way of an example.

FIG. 1, already described, illustrates a loop antenna according to the prior art.

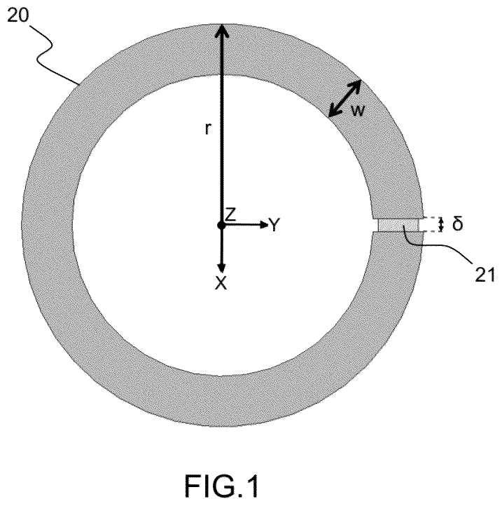

FIG. 2, already described, illustrates radiation patterns of the loop antenna according to FIG. 1, for various values of C/k

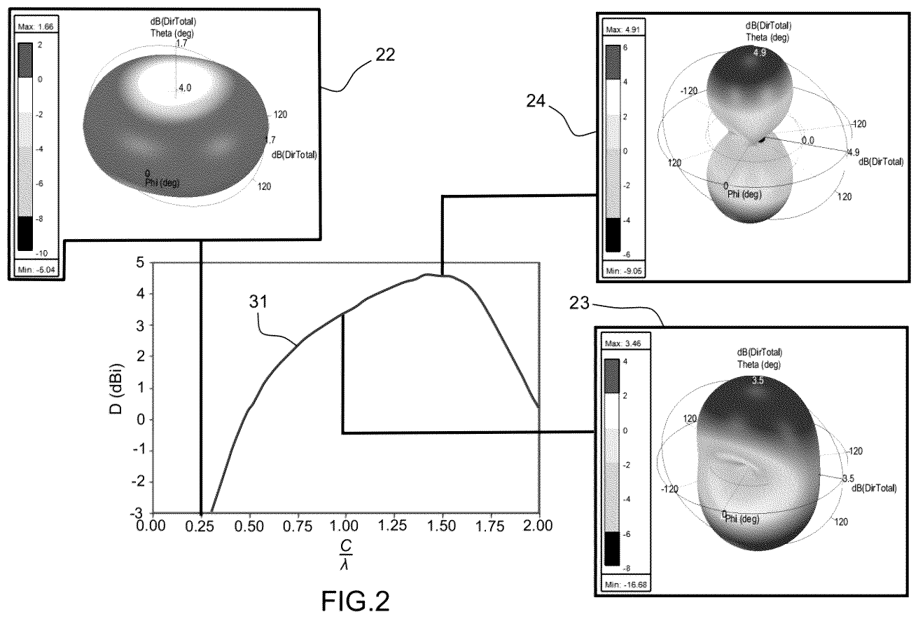

FIG. 3 illustrates an antenna according to the invention.

FIG. 4 illustrates radiation patterns of the loop antenna according to the invention, and according to FIG. 5, for various values of C/k

FIG. 5 illustrates a loop antenna devoid of a central element, and where the loop is excited on either side at two connection ports.

FIG. 6 shows an embodiment of an antenna system comprising an antenna and a reflector element.

FIG. 7 illustrates an embodiment of several antennas according to the invention arrayed in an “End-Fire” type configuration.

FIG. 8 illustrates an embodiment of an antenna system comprising a reflector element and several antennas according to the invention arrayed in an “End-Fire” type configuration.

### DETAILED DESCRIPTION

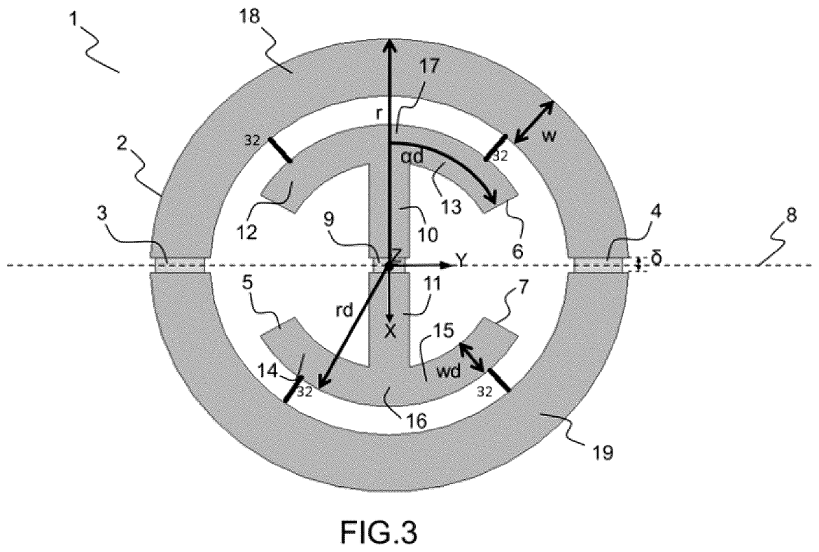

The antenna according to the invention is shown in FIG. 3.

The antenna 1 comprises a main radiating element 2 of the loop antenna type. In FIG. 3, the loop is circular, but other shapes can be contemplated for the loop, notably square or rectangular shapes, or even loops with more complex shapes of the polygonal surface or volume type. The specific shape depends on the application and the desired performance features. The main radiating element 2 is a loop of conductive wire or a printed metal track in the form of a loop.

The printed metal track, typically comprising copper, can be produced on a dielectric substrate using PCB (Printed Circuit Board) type technology.

The substrate can be manufactured from materials such as epoxy glass fiber (FR-4) or polytetrafluoroethylene (PTFE), although other materials can be used depending on the specific requirements of the antenna.

The main radiating element 2 is located in the xy-plane, which means that its thickness, along the z-axis, is negligible compared to the width of the loop, in the xy-plane.

A central element 5 of the electric dipole type is circumscribed in the main radiating element 2. The central element 5 is formed by a first branch 6 and a second branch 7. The two branches are disposed symmetrically relative to an axis of symmetry 8 that passes through a first connection port 3 and through a second connection port 4.

The central element 5 of the electric dipole type is powered by a balanced two-wire line represented by a connection point at the center of the dipole. One of the poles is excited in phase opposition to the second pole, which can be achieved by balanced excitation at the output of a symmetrizing circuit (by a device referred to as “balun”).

The first connection port 3 and the second connection port 4 are disposed on either side of the main radiating element 2, i.e. diametrically opposite relative to the center of the loop. The arrangement on either side of the main radiating element 2 (relative to the center of symmetry) can be equally applied to a circular loop antenna and to the other forms of loop antenna as mentioned above.

The number of connection ports can be greater than two, provided that the symmetry with respect to the axis 8 is followed.

According to a first embodiment, one of the connection ports (for example, the first connection port 3) comprises a load, and the other connection port (for example, the second connection port 4) comprises a power supply circuit.

The power supply circuit acts as an electrical link between the main radiating element 2 and the transmit/receive electronics of the antenna. The electrical signals generated by the antenna (in the case of reception) or the electrical signals intended to be transmitted by the antenna (in the case of transmission) are transmitted through the power supply circuit.

In this embodiment, the load is a “passive” load, and can include a resistor. However, active loads also can be contemplated, allowing impedances to be achieved with negative real parts.

The loads can be designed with equivalent series or parallel RLC circuits.

According to a particularly advantageous embodiment, each of the connection ports comprises a power supply circuit. The symmetry of the dipole relative to the axis of symmetry 8 allows balanced coupling on the loop (two excitation points per coupling). This allows the dipole to be powered at the center and the two ports of the loop to be weighted with the same set of loads. Applying two symmetrical loads to the main radiating element allows the radiation to be kept orthogonal to the xy-plane containing the loop.

The antenna 1 according to the invention comprises a central element 5 of the electric dipole type, circumscribed in the main radiating element 2. “Circumscribed” is understood to mean that the central element 5 is contained within specific limits defined by the inside of the loop of the main radiating element 2.

The central element 5 is powered at a third connection port 9 located on the axis of symmetry 8. The third connection port 9 comprises a power supply circuit. In addition, the third connection port 9 can include an impedance matching circuit including series and/or parallel loads.

The central element 5 is located in the same plane as the main radiating element 2. The fact that they are located in the same plane allows the inter-element space to be reduced, compared to a configuration in which one of the two elements would be outside the plane. The arrangement of the main radiating element 2 and of the central element 5 in the same plane simplifies the installation of the first connection port 3 and of the second connection port 4.

Due to the coplanar nature of the central element 5 and of the main radiating element 2, it is possible to connect a complex coupling circuit 32 between the central element 5 and the main radiating element 2 (for example, a series or parallel RLC circuit). This more complex coupling would be difficult or even impossible to integrate if the main radiating element 2 was outside the plane of the central element 5 (in this case, the coupling solely occurs by capacitive coupling via the capacitance distributed between the main radiating element 2 and the central element 5). Thus, by adjusting the loads of the complex coupling circuit, it is possible to obtain different radiations without modifying the initially planned radiating structure.

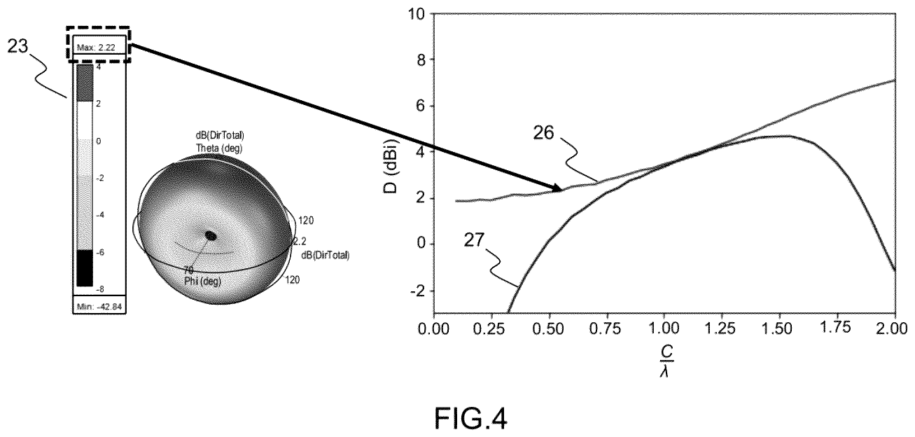

FIG. 4 illustrates radiation patterns obtained for different values of C/λ (C corresponds to the circumference of the main radiating element 2 and X corresponds to the wavelength of the carrier), with the central element 5 (patterns 20, 21 and 22) and without the central element (patterns 23, 24 and 25). Each of the radiation patterns shows the directivity of the antenna, i.e. the directions along which the antenna best radiates or picks up the electromagnetic signals.

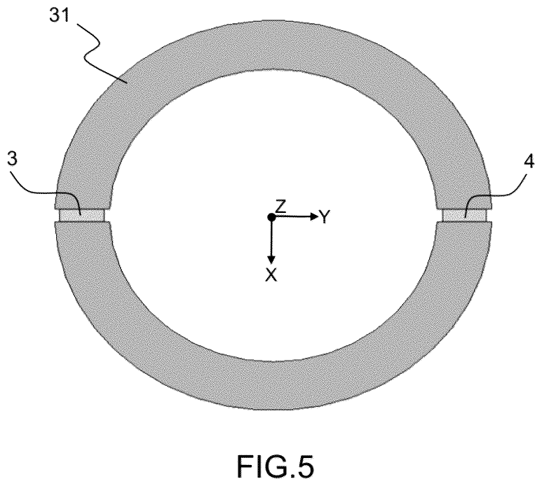

FIG. 4 also illustrates the directivity of the antenna along the z-axis of FIG. 3, i.e. the axis orthogonal to the plane of the loop (see curve 26 with the central element and curve 27 without the central element). FIG. 5 illustrates the loop antenna 31 devoid of a central element, used to plot the curve 27, and whose loop is excited on both sides at the first connection port 3 and the second connection port 4 with the correct phase distribution.

It would appear that for C/λ<1 and C/λ>1.25, and in particular C/λ=0.25, the antenna equipped with the central element radiates in the plane orthogonal to the plane of the antenna (called “broadside” radiation). The radiation pattern 23 with the central element, for C/λ=0.25, shows that there is maximum directivity in the z-axis and good symmetry of the pattern.

This radiation feature, even for low values of C/λ, means that it is possible to contemplate several antennas according to the invention being arrayed in an “End-Fire” type configuration. Thus, at a constant wavelength, the circumference of the antenna can be reduced, without the directivity being affected outside the plane.

An arrayed “End-Fire” type configuration involves aligning a plurality of antennas along the axis orthogonal to the plane of each antenna. By concentrating energy in a specific direction (which corresponds to the orthogonal axis), “End-Fire” type antennas provide high gain in this direction, which improves the effective power of the signal transmitted or received in this direction.

An embodiment of the antenna according to the invention will now be described with reference to FIG. 3. The branch 6 of the central element 5 comprises a main strand 10 that extends orthogonal to the plane (or axis) of symmetry 8, and two auxiliary strands (12 and 13), disposed on either side of the end 17 of the main strand 10 opposite the third connection port 9.

“Strand” (main strand or auxiliary strand) is understood to mean an elongated and relatively thin part.

Thus, each auxiliary strand forms an arc of a circle that extends from the end 17 of the main strand, at an angle ad ranging between 0° and 90° (excluding these values), and the main radiating element 2 is made up of two semi-circles. If the main radiating element 2 assumes another shape, each auxiliary strand assumes a shape such that there is a free space (devoid of a metal track) between the auxiliary strand and the inside of the main radiating element 2, so as to reveal coupling zones between the main radiating element 2 and the central element 5. For example, if the main radiating element 2 is square, the auxiliary strands are straight, so as to be parallel to the main radiating element 2.

Symmetrically, the branch 7 of the central element 5 comprises a main strand 11 that extends orthogonal to the plane of symmetry 8, and two auxiliary strands (14 and 15), disposed on either side of the end 16 of the main strand 11 opposite the third connection port 9.

The dimensions of the main radiating element 2 and of the central element 5 are determined so that the impedance of the first connection port 3 and of the second connection port 4 has a real part that is as low as possible, in particular a zero or virtually zero real part. “Virtually zero” is understood to mean a real part that is much lower than the radiation resistance of the antenna (of the order of at least a hundred times lower).

This allows the central element 5 to be powered centrally and the two connection ports (3, 4) of the main radiating element 2 to be weighted with the same set of loads. Thus, the planes of phases of the main radiating element 2 and of the central element 5 are co-located.

Furthermore, adding a central element 5 to the center of the main radiating element 2 allows the impedance of the first connection port 3 and of the second connection port 4 to be optimized, by adjusting a plurality of parameters, and not only the track width w of the main radiating element 2, as is the case in the loop antennas of the prior art.

Thus, when designing the antenna, the designer can adjust at least one of the following parameters, so as to weight the two connection ports with the same set of loads: the diameter r of the main radiating element 2, the width w of the main radiating element 2, the spacing δ between each of the semi-circles (18, 19) that form the main radiating element, the diameter rd of the arcs of a circle (12, 13, 14, 15), the width wd of the arcs of a circle (12, 13, 14, 15), and the length ad of the arcs of a circle (12, 13, 14, 15).

For example, an antenna according to the invention can be implemented with the values shown in the following table (units shown in brackets):

| λ (m) | r (m) | w (m) | δ (m) | rd (m) | wd (m) | αd (°) |
|---|---|---|---|---|---|---|
| 0.3 | 0.25 · λ/2π | λ/100 | λ/400 | λ · (r-2.5 w) | λ/300 | 70 |

For these values, the following impedances (in Ω) are obtained, respectively at the first connection point 3 and the second connection point 4:

$$Z 3 = 0 + 1 j ⋆ 535$$

$$Z 4 = 0 + 1 j ⋆ 535$$

The impedances at the connection points are identical, which guarantees balanced coupling at the main radiating element 2, and radiation that remains orthogonal to the plane of the loop, even with a low value of C/λ (C/λ=0.25).

Load optimization can be implemented by applying a superdirectivity algorithm, which allows the complex amplitudes at the antenna connections, i.e. directly at the loads and/or power supply points, to be obtained analytically (i.e. by solving a linear system of equations).

An example of a superdirectivity algorithm is described in [9].

Preferably, the superdirectivity algorithm uses a radiation pattern method, which is easy to implement. Indeed, it does not require an iteration or even decomposition in a particular base.

As a variant, load optimization can be implemented using other methods, notably by the spherical mode method or even by the characteristic mode method.

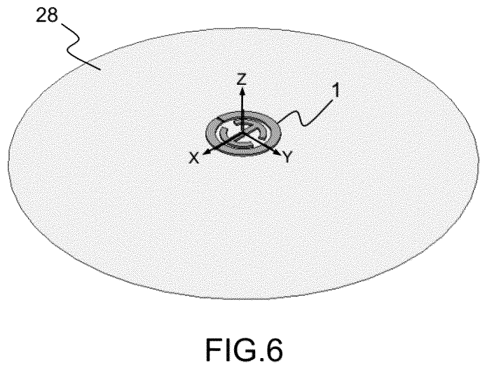

FIG. 6 illustrates an antenna system, comprising an antenna 1 as defined above, and a reflector element 28 placed close to the main radiating element and parallel to the plane of the main radiating element.

This configuration provides an increase in directivity in the plane orthogonal to the antenna. In particular, the increase in directivity can be a factor of 2 if the reflector is a good metal conductor with a diameter that is greater than the wavelength.

The reflector is flat and can have a diameter of the order of the wavelength of the transmit/receive signal. The effects on directivity are significant as the antenna approaches the reflector element 28 (for example, by a distance that is equal to 0.1λ). However, the closer the antenna 1 approaches the reflector element 28, the more difficult it becomes to match the impedance of the reflector element 28. A compromise between improved directivity and impedance matching therefore must be made.

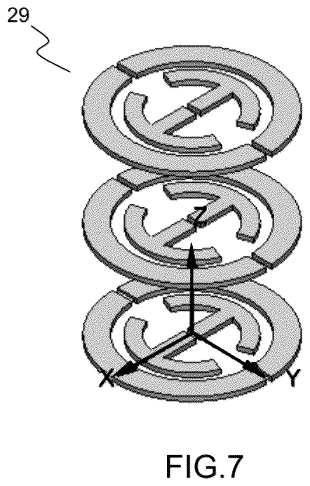

FIG. 7 illustrates an antenna array 29 according to the invention. It comprises at least two antennas as described above, arrayed in an “End-Fire” configuration. The central elements of the various antennas do not need to be aligned. The antennas radiate along the axis orthogonal to the plane of the loop, which is particularly compatible with being arrayed.

Indeed, the axis of maximum radiation is aligned with the axis of duplication of the radiating elements, and the space between the antennas can be significantly reduced due to the flat nature of the antenna and the central element. This allows a highly compact and highly directive array to be obtained.

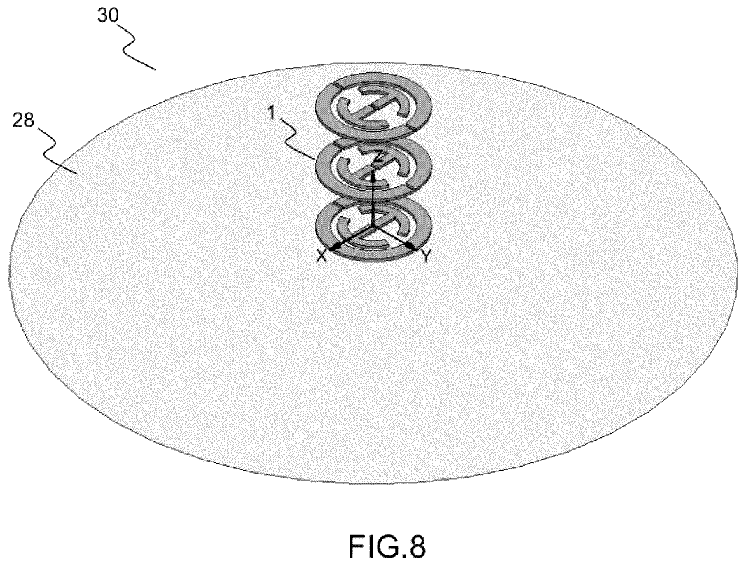

The embodiments of the system with a reflector and of antennas being arrayed in an “End-Fire” type configuration can be combined, as shown in FIG. 8.

The antenna array 30 comprises a plurality of arrayed antennas 1 placed opposite a reflector 28.

### CITED REFERENCES

[1] Balanis, C., 2005. Antenna theory. New York: Wiley-Interscience.
[2] Pigeon, M., Delaveaud, C., Rudant, L., & Belmkaddem, K. (2014). “Miniature directive antennas”. International Journal of Microwave and Wireless Technologies, 6(1), 45-50. doi:10.1017/S1759078713001098.
[3] R. W. Ziolkowski, M. -C. Tang and N. Zhu, “An efficient, electrically small antenna with large impedance bandwidth simultaneously with high directivity and large front-to-back ratio”, 2013 International Symposium on Electromagnetic Theory, Hiroshima, Japan, 2013, pp. 885-887.
[4] EP2178166A1, “Loop antenna including impedance tuning gap and associated methods”.
[5] U.S. Pat. No. 7,298,343B2, “RFID tag with enhanced readability”.
[6] O. S. Kim, S. Pivnenko and O. Breinbjerg, “Superdirective Magnetic Dipole Array as a First-Order Probe for Spherical Near-Field Antenna Measurements”, in IEEE Transactions on Antennas and Propagation, vol. 60, no. 10, pp. 4670-4676, October 2012, doi: 10.1109/TAP.2012.2207363.
[7] S. Ito, N. Inagaki and T. Sekiguchi, “An investigation of the array of circular-loop antennas”, in IEEE Transactions on Antennas and Propagation, vol. 19, no. 4, pp. 469-476, July 1971, doi: 10.1109/TAP.1971.1139954.
[8] F. Munoz et al., “Compact Superdirective Electric Dipole Array for Far-field Measurement in a Semi-Anechoic Environment”, 2023 17th European Conference on Antennas and Propagation (EuCAP), Florence, Italy, 2023, pp. 1-5, doi: 10.23919/EuCAP57121.2023.10133657.
[9] E. E. Altshuler, T. H. O'Donnell, A. D. Yaghjian, and S. R. Best, “A Monopole Superdirective Array”, IEEE Transactions on Antennas and Propagation, vol. 53, no. 8, August 2005.

1. An antenna comprising a main radiating element of the loop antenna type, a first connection port and a second connection port disposed on either side of the main radiating element, a central element of the electric dipole type, circumscribed in the main radiating element, the central element being formed by two branches disposed symmetrically relative to an axis of symmetry passing through the first connection port and through the second connection port, the central element being powered at a third connection port located in the axis of symmetry, wherein the main radiating element and the central element are coplanar.

2. The antenna according to claim 1, wherein the dimensions of the main radiating element and of the central element are determined so that the impedance of the first connection port and of the second connection port have a zero real part.

3. The antenna according to claim 1, wherein each branch of the central element comprises a main strand that extends orthogonal to the axis of symmetry, and two auxiliary strands disposed on either side of the end of the main strand opposite the third connection port.

4. The antenna according to claim 3, wherein the main radiating element is made up of two semi-circles connected at the first connection port and the second connection port, and the auxiliary strands assume the shape of an arc of a circle, and wherein the following parameters are used to optimize the impedance of the first connection port and of the second connection port: the diameter of the main radiating element, the width of the main radiating element, the spacing (δ) between each of the semi-circles, the diameter (rd) of the arcs of a circle, the width of the arcs of a circle, and the length (αd) of the arcs of a circle.

5. The antenna according to claim 1, wherein the impedance of the first connection port and the impedance of the second connection port are determined by applying a superdirectivity algorithm.

6. The antenna according to claim 5, wherein the superdirectivity algorithm uses a radiation pattern method.

7. The antenna according to claim 1, wherein the first connection port and the second connection port each comprise a power supply circuit.

8. The antenna according to claim 1, wherein the first connection port comprises a load, and the second connection port comprises a power supply circuit.

9. The antenna according to claim 1, wherein a coupling circuit is connected between the central element and the main radiating element.

10. The antenna according to claim 9, wherein the coupling circuit is a series or parallel RLC circuit.

11. An antenna system, comprising an antenna according to claim 1, and a reflector element placed close to the main radiating element and parallel to the plane of the main radiating element.

12. An antenna array, comprising at least two antennas according to claim 1, the antennas being arrayed according to an “End-Fire” type configuration.
